(19) United States
(12) Patent Application Publication
(10) Pub. No.: US 2026/0203522 A1
(43) Pub. Date: Jul. 16, 2026

(54) Intelligent Real-Time User Interface Analysis and Guidance Generation Using Reference Resolution Mode

(71) Applicant: Bank of America Corporation, Charlotte, NC (US)

(72) Inventors: Saurabh Arora, Haryana (IN); Sandeep Kumar Chauhan, Telangana (IN)

(21) Appl. No.: 19/016,293

(22) Filed: Jan. 10, 2025

(51) Int. Cl. G06F 40/40; G06F 9/451

(52) U.S. Cl. CPC G06F 40/40; G06F 9/451

(57) ABSTRACT

To enhance the efficiency of user application, a system and method may be configured to analyze a user interface as well as user interactions with that interface in order to dynamically generate and provide guidance information. In some examples, the system and method may apply a reference resolution model generated based on historical resolutions and user interface content and interactions. Additionally or alternatively, guidance information may be provided in different manners, including proactive and reactive guidance.

### BACKGROUND

Aspects described herein relate to electrical computers, networks, systems, and devices for analyzing content and user interactions in a user interface and generating automated interactions, feedback and guidance for the user interface using one or more reference models.

Computer interactions are present in routine aspects of daily life. These interactions range from electronic communications to shopping to entertainment to financial transactions. These applications are used at home, in business, and within communities. Computer interactions are generally facilitated through computer user interfaces that may display or otherwise convey a variety of information. User interfaces may also be configured to receive various user input. For example, a user interface may be provided to configure a network router and may include a variety of user input fields such as IP address, port numbers and the like. In another example, a computer application may provide a user interface for executing electronic payments. In yet another example, a computing application may have a user interface for streaming audio or video content.

In some cases, the user interface may provide information or request information or instructions for performing a process that is not easily understood by a user. Unless there is pre-existing help information, guidance or other feedback that the user can access, a user is typically left to their own devices to determine how best to proceed through the interface and corresponding application. In some cases, an application, interface, or system may provide help documentation. However, the help documentation might not be able to anticipate every issue a user might have and/or provide help information in a manner or format most conducive to assisting a particular user. In other cases, a live chat or contact center may be provided to help users. While this feedback might be personalized, the user may need to wait in a queue to obtain the requisite assistance and the assistance may be limited to the knowledge of the assisting individual. In other examples, the user may still need to independently navigate the user interface since the live chat or contact center might not have the ability to see or access the user's interface.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

By addressing one or more of the above noted challenges, computer applications (e.g., desktop applications, web applications, mobile applications) may provide dynamic, customized, and intelligent user interface guidance and other feedback to assist users in navigating through a computer application.

Aspects described herein relate to systems, methods, apparatuses and processes for analyzing user interaction with a computer application and dynamically and intelligently generating guidance and assistance. For example, a computer application may monitor and analyze various characteristics of a user's interaction with a computer application and one or more of its user interfaces. Such characteristics may include an amount of time a user spends on a particular interface, portion of an interface, input field, section of a form, and the like and/or combinations thereof, a number of times a user selects one or more help icons, a pace through which the user moves from interface to interface (e.g., in a multi-screen or multi-interface application), a number of times a user revisits (e.g., cursors over, places focus on) an input element or section of the interface, and the like and/or combinations thereof. Using the collected characteristics, the system and method may determine guidance or feedback such as prompts, instructional video, audio and/or text, images, and the like for assisting the user through one or more interfaces. In one or more arrangements, the guidance may include modifying one or more interface elements such as a display order of input fields, adding a help option to one or more portions of an interface, modifying a type of input or input field, modifying a question or input prompt for an input field, and the like. In still other examples, the guidance may include one or more real-time information displays that provides assistance as the user proceeds through one or more portions of an interface.

According to one or more aspects, the collected interaction characteristics may include historical user interactions with that same application or different applications. Additionally, the collected historical information may include interactions of other users with that same application or different applications. In still other arrangements, the feedback may be collected by categorizing types of interfaces, types of input fields, types of application, types of user, time and/or date, and the like and/or combinations thereof. The characteristics from a current user session (e.g., current use/interaction with an application) may be combined with historical characteristics in order to determine feedback for the current user session.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for a guidance and feedback generation system in accordance with one or more aspects described herein;

FIG. 2 is a system diagram illustrating a process flow through which interface and application elements are analyzed and guidance is dynamically generated according to one or more aspects described herein;

FIG. 3 is a flowchart illustrating an example process for analyzing user input and interface content and dynamically generating resolution information according to one or more aspects described herein;

FIG. 4 illustrates an example graphical user interface for an application including dynamically generated guidance information according to one or more aspects described herein; and

FIG. 5 depicts an illustrative architecture and operating environment for a dynamic feedback and guidance generation system according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, a computer application may include a variety of interactive features that may require user interaction such as user input. In some cases, the user interfaces might not be as intuitive or easy to understand for some users, and in such cases, further assistance may be desired. For example, a user might not understand the type of information requested in a particular input field. In another example, a user might not know where to obtain information to be inputted into a section of the user interface. In yet another example, a user might not understand that they need to view a video (or otherwise interact with the interface in a particular way) in order to advance through the application or interface. A variety of other circumstances may call for additional support or assistance to help a user move through an application or interface more efficiently.

Accordingly, systems, methods, and apparatuses described herein provide for dynamic and intelligent feedback and guidance generation for a user interface based on analyzing real-time user interactions, historical interaction information, interface information and content, and the like. In one example, the systems, methods and apparatuses may modify audio, visual, textual and/or haptic elements of a user interface based on a particular user. Those modifications may be determined based on a manner in which the user has interacted with the application or interface in a current session and/or based on past interactions with the same application or interface or other applications or interfaces.

In some examples, the dynamic and intelligent guidance and feedback may include real-time instructions or other information generated and displayed as part of an interface. As a user proceeds through an interface, one or more portions of the interface may be designated to provide additional instructions or guidance based on the user interactions and interaction characteristics up to that point. In one arrangement, the feedback may be provided as part of a running chat session or other feedback window. Additionally or alternatively, the feedback may include customized prompts for guiding a user through a process.

By allowing for real-time and dynamic guidance and feedback and updating of user interfaces, users may find use of an application to be more efficient, helpful, and/or enjoyable. In some examples, users may find completing processes provided through an application to be faster and more efficient. This may, in turn, reduce processing requirements on an application server or other back-end system supporting the application and/or a local device on which the application is executing.

These and various other arrangements will be discussed more fully below.

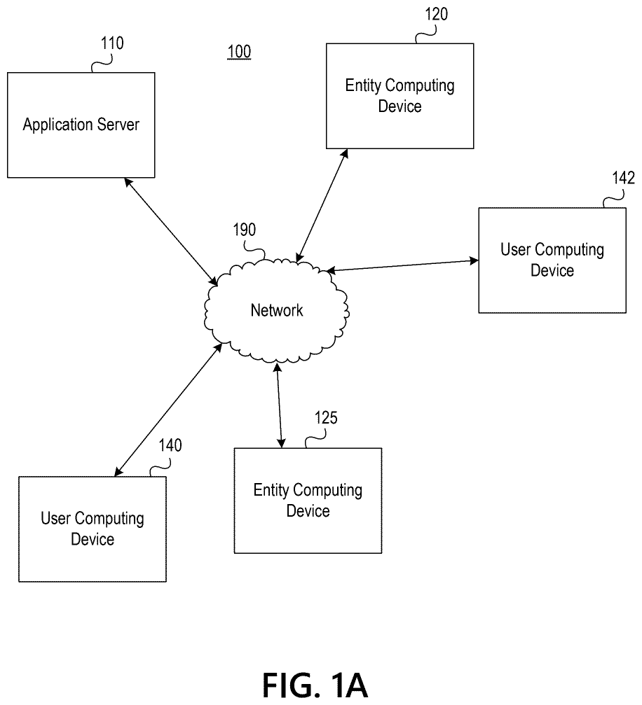

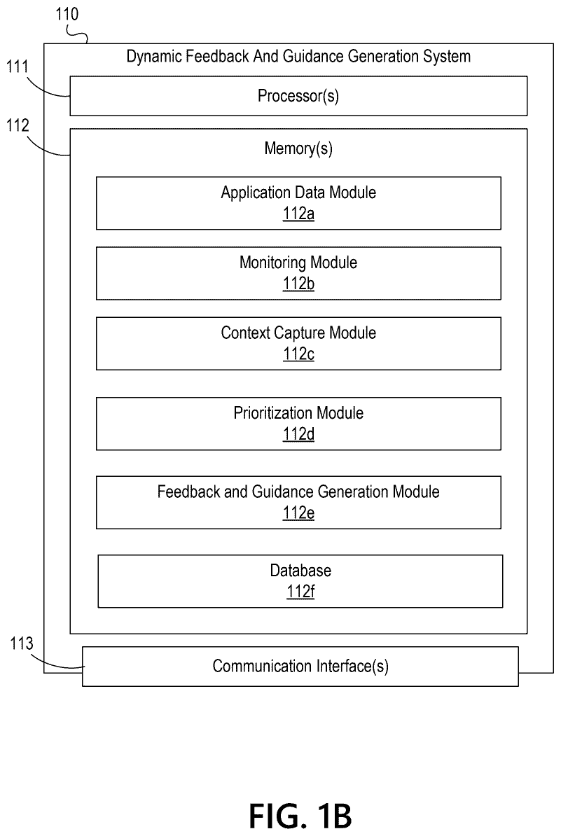

FIGS. 1A-1B depict an illustrative computing environment for implementing a computer application customization and modification system and process in accordance with one or more aspects described herein. Referring to FIG. 1A, computing environment 100 may include one or more computing devices and/or other computing systems. For example, computing environment 100 may include an application server or system 110, entity computing systems 120, 125, and user computing devices 140, 142. Although one application server 110, two entity computing systems 120, 125 and two user computing devices 140, 142 are shown, any number of systems or devices may be used without departing from the invention.

Application system or server 110 may include one or more computing devices (e.g., servers, personal computers (PCs), routers, mobile devices, server blades, or the like) and/or one or more computing components (e.g., memory, processor, and the like) and may be configured to perform a variety of functions and have a variety of capabilities for an organization, entity, or system. In one example, the application system or server 110 may correspond to a web server configured to host one or more multimedia processing applications (e.g., image editing, video processing, audio editing). In another example, the application system or server 110 may correspond to a financial transaction system configured to provide financial transaction applications and processes such as for payments, loans, withdrawals, deposits, auditing, and reporting. In still another example, application system or server 110 may correspond to an electronic security system configured to store, manage, provide, and execute applications for configuring, monitoring and/or controlling a home or office security system. In each of these arrangements, server 110 may be configured to communicate with and serve applications to a plurality of devices including user computing devices 140, 142 as well as entity computing systems 120 and 125.

Application system or server 110 may further be configured to detect, receive, or otherwise obtain information about user interactions with the applications that it hosts. For example, the application system or server 110 may monitor user interactions with applications, including user input, user focus (e.g., cursor movements, scrolling), navigation from one screen to another, and the like. In one or more arrangements, application system or server 110 may further allow users to download its applications onto their local device (e.g., entity computing system 120 or user computing device 140). In other examples, users may access and execute applications through application system or server 110 (e.g., application system or server 110 runs the applications while providing the output to the user devices). In some cases, the application system or server 110 may determine how well (e.g., quickly, efficiently) a user is progressing through a process provided by the application, and determine whether assistance might be required. This determination may be made based on explicit user actions (e.g., requesting help) or through inference based on the user's interactions with an application. For example, the system or server 110 may determine that a user is taking a long time to select a loan type, interest rate and/or loan term. Based on this monitoring, the system or server 110 may determine that the user may require additional guidance for making these selections and decisions and progressing through the loan application. In other examples, the system or server 110 may detect that the user has selected multiple help options when the user is navigating through a particular section (e.g., portion of a user interface, a particular input field) of a network configuration application. Based on this detection, the system 110 may determine that additional guidance would be helpful to assist the user in completing that portion of the network configuration process.

According to one or more arrangements, application system or server 110 may further perform image and textual analysis on portions of the application interface and/or the user input to determine a context of a user's current interaction with the application. For example, the application system or server 110 may obtain a screen capture or other image capture of a current screen or interface. The image, along with text or images therein, may then be analyzed using language models and image models to determine topics associated with the current screen or interface. Accordingly, if a user inputs a question into an automated live-chat feature that asks “How do I calculate my monthly payment?”, the system 110 may know that the question refers to an automobile loan by processing and analyzing the captured image of the user interface currently being viewed. In another example, a user may click a help button while viewing a certain portion of a user interface for activating a user's new mobile communication device. The system 110 may capture the text and/or images in the portion of the user interface to determine that the user needs help with identifying the mobile communication device's IMEI code.

Entity computing system 120 and/or entity computing system 125 may be or include one or more computing devices (e.g., servers, routers, gateways, network nodes, personal computers (PCs), mobile devices, server blades, or the like) and/or one or more computing components (e.g., memory, processor, and the like) and may be configured to host or execute one or more organization applications or systems. For instance, entity computing system 120 and/or entity computing system 125 may host or execute internal or user-facing applications or systems that may be accessed by one or more users in-person or remotely, such as via a network, such as a private network, public network, or the like. In one example, entity computing system 120 and 125 may include computers operated by employees of an organization. Those systems 120 and 125 may download or otherwise access applications provided by application server 110. According to one or more arrangements, entity computing systems 120 and 125 may be terminals configured to be operated by a customer for providing products or services, general purpose computing devices providing function-specific applications, and/or function-specific devices such as ATMs, maintenance devices, electronic vaults, cash registers, points of sale system, and the like and/or combinations thereof.

User computing devices 140 and 142 may be or include a computing device such as a desktop computer, laptop computer, tablet, smartphone, wearable device, and the like, that is associated with an internal or external user (e.g., internal or external to an organization corresponding to the application server 110). User computing devices 140, 142 may communicate with application server 110 and/or entity computing systems 120, 125 to access various application and perform computing activities and transactions. In some arrangements, the user computing devices 140, 142 may be mobile devices executing an application used to configure a security monitoring system or to perform financial transactions. In other examples, the user computing device 140 may be an employee computer or computing device used to review, confirm and/or approve transactions, communications, and the like. For example, if a request is made to transact a large amount of money, the approval or confirmation may be entered through user computing device 140 and/or 142. In still other examples, user computing devices 140, 142 may be user devices executing a web browser through which web applications may be accessed and used. Examples of such web applications include local area network configuration tools, security monitoring tools, banking web applications, web-based chat applications and the like and/or combinations thereof.

As mentioned above, computing environment 100 also may include one or more networks, which may interconnect one or more of application server or system 110, entity computing system 120, entity computing system 125, user computing device 140, and/or user computing device 142. For example, computing environment 100 may include network 190. Network 190 may include one or more sub-networks (e.g., Local Area Networks (LANs), Wide Area Networks (WANs), or the like). Network 190 may be associated with a particular organization (e.g., a corporation, financial institution, educational institution, governmental institution, or the like) and may be a private network interconnecting one or more computing devices associated with the organization. For example, application server 110, entity computing system 120, entity computing system 125, user computing device 140, and/or user computing device 142 may be associated with an organization (e.g., a financial institution), and network 190 may be associated with and/or operated by the organization, and may include one or more networks (e.g., LANs, WANs, virtual private networks (VPNs), or the like) that interconnect transaction processing and dispute resolution system 110, entity computing system 120, entity computing system 125, user computing device 140, and/or user computing device 142 and one or more other computing devices and/or computer systems that are used by, operated by, and/or otherwise associated with the organization. Additionally or alternatively, network 190 may be a public network, such as the internet, that may connect the systems and devices described. In yet other examples, network 190 may include a combination of public and private networks.

Referring to FIG. 1B, a dynamic feedback and guidance generation system such as application server 110 may include one or more processors 111, memory 112, and communication interface 113. A data bus may interconnect processor(s) 111, memory 112, and communication interface 113. Communication interface 113 may be a network interface configured to support communication between dynamic feedback and guidance system 110 and one or more networks (e.g., network 190, or the like). Memory 112 may include one or more program modules having instructions that when executed by processor(s) 111 cause dynamic feedback and guidance system 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of the dynamic feedback and guidance system 110 and/or by different computing devices that may form and/or otherwise make up dynamic feedback and guidance system 110.

For example, memory 112 may have, store and/or include application data module 112a. Application data module 112a may be configured to store a variety of applications, and code and data for those applications. For example, application data module 112a may store financial application for an organization (e.g., a financial institution) or network configuration applications for a network device company. In yet other examples, application data module 112a may be provide data for hosting an application marketplace or warehouse through which users may purchase or otherwise obtain applications to execute on a local device. In still other examples, application data module 112a may store applications available through one or more web-based channels. Application data module 112a may also store data used by the application, such as customer information, product information, financial information and the like and/or combinations thereof. Application data module 112a may further store user-specific data for an application such as stored game progress data for a gaming application, or customer-entered information for a loan application. In still further arrangements, application data module 112a may store application interaction information indicating how one or more users have previously interacted with the application in the past. For example, application data module 112a may store information such as an amount of time a user took to complete a form or a user interface (or portion of the interface) for an application, portions of a user interface where a user has previously requested assistance (e.g., invoking a live chat or selecting a help icon), whether a user has navigated backwards or forwards from one interface to another in an application, a sequence in which a user completes an application process, and the like and/or combinations thereof. At least a portion of the interaction information may be obtained using monitoring module 112b described below.

Memory 112 may further have, store and/or include an interaction monitoring module 112b. Monitoring module 112b may be configured to monitor for user interactions with various aspects or portions of applications. In one example, monitoring module 112b may detect user input such as user clicks, other types of user selections (e.g., click-and-select), cursor movement on an interface, navigation between interfaces of an application and the like, identify particular interface elements or portions of the interface with which the user interacts, and determine an amount of time spent by a user on an interface or portion of an interface. Monitoring module 112b may further interface with context capture module 112c (described in further detail below) to record or otherwise monitor a context during which one or more interactions are detected. In some examples, monitoring module 112b may further monitor for a possible need for user assistance. Such monitoring may include determining whether there is an error in the interface currently be accessed by the user (e.g., an application or system error). In another example, monitoring may include determining whether an upcoming workflow of the application or interface may require additional user guidance. This determination may be made based on historical user interactions with the same portion of the application or interface. In yet another example, a need for user assistance may be detected based on a pace with which the user has progressed through prior portions of the interface or application. In some arrangements, the longer it takes the user to progress through one or more portions of an interface, the more likely the system 110 is to determine that the user requires assistance. In still other examples, a monitoring module 112b may explicitly request assistance.

Memory 112 may further have, store and/or include a context capture module 112c. Context capture module 112c may be configured to capture images, text, video, metadata, and the like associated with a current user interface or portion of the user interface being viewed by a user. As discussed above, using these captures images, text, video, and/or metadata, a monitoring module 112b or other module of the system 110 may determine a context associated with a user's request for assistance of guidance or a detected need for user guidance or assistance. The context capture module 112c may, for example, obtain screenshots or screen captures of a current application window. The context capture module 112c may also extract text and other data associated with a current application interface or window. In some arrangements, the context capture module 112c may perform optical character recognition (OCR) on a captured screen image and extract the text and other characters, symbols, and the like from the OCR result. In other examples, the context capture module 112c may parse code associated with the displayed interface (e.g., HTTP code) to identify images, text, video and/or metadata that may provide context to a user's inquiry or request for assistance. Content that is not directly embedded in the interface and that identifies a source from which the content is to be retrieved, may be retrieved using that source information (e.g., retrieving a video from a HTTP URL).

Memory 112 may further have, store and/or include a prioritization module 112d. Prioritization module 112d may be configured to determine a priority of feedback or other assistance that is to be presented to the user. For example, a user may have multiple requests for assistance or inquiries. In another example, a user's current interaction may indicate a need for the user to receive multiple instructions to assist their progress through the application. In such examples, the system 110 may need to prioritize the various feedback that is to be provided. Accordingly, prioritization module 112d may determine a sequence or priority of the instructions based on a variety of factors. One factor may be a sequence in which multiple steps are to be performed in order to complete or otherwise progress through a user interface or an application process. Another factor may be a sequence in which multiple user inquiries were received. Yet another factor may include an order in which various elements of the interface associated with the guidance is presented in the interface. Still another factor may be a complexity of each piece of guidance. In some cases, priority may be used to determine placement of multiple pieces or types of feedback within the user interface.

Memory 112 may further have, store and/or include a feedback and guidance generation module 112e configured to generate the feedback or guidance needed to respond to a user's request for assistance or guidance or a detected need for user guidance or assistance. Feedback and guidance may be generated and provided in multiple ways. In one arrangement, feedback and guidance generation module 112e may be configured to generate a non-interactive guide prompt that provides instructions and other guidance on how to progress through an interface or application. Feedback and guidance generation module 112e may further be configured to generate an interactive conversation prompt through which a user may submit queries, requests, and the like and receive computer-generated responses. The non-interactive guide prompt, in some arrangements, may be generated proactively (e.g., without needing to be responsive to user input or quest, and/or without requiring user input), while the interactive conversation prompt may respond to user queries and input. In some examples, the interactive conversation prompt may also provide guidance proactively (i.e., without being responsive to user input or without requiring user input).

Feedback and guidance generation module 112e may use a dual reference resolution model to generate feedback. The dual reference resolution model may use both user input (e.g., queries, questions, input) as well as non-user-inputted on-screen or on-interface information to determine the necessary feedback and guidance. For example, the feedback and guidance generation module 112e may receive a user query such as “How many digits is the serial number?” when completing a warranty registration form. The feedback and guidance generation module 112e may analyze the user-inputted query as well as obtain context from the on-screen information that is not provided by the user to better understand the inquiry. For example, the on-screen information may include a picture of a refrigerator or have text such as “Refrigerator Warranty Registration Submission.” Accordingly, based on the dual references (user query and on-screen information), the system 110 may determine that the query relates to a serial number for a refrigerator (e.g., as opposed to a microwave which may have a different type, structure, or format of serial number) and provide the appropriate feedback and guidance.

Dynamic feedback and guidance generation system 110 may further have, store and/or include database 112f. Database 112f may store further data, beyond what is stored in or by application data module 112a. For example, database 112f may store and/or other data that enables performance of aspects described herein by the dynamic feedback and guidance generation system 110.

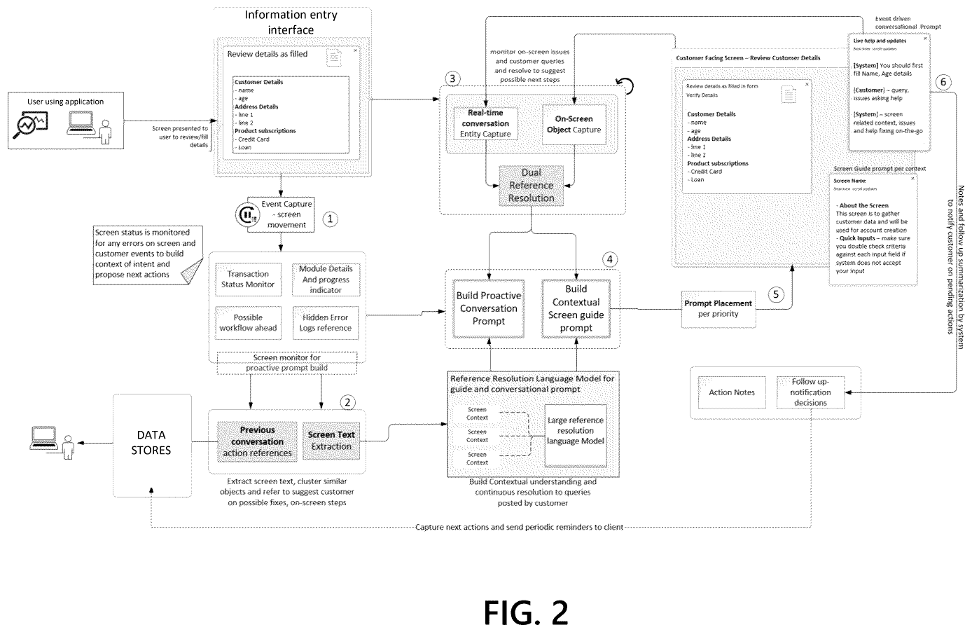

FIG. 2 is a schematic diagram illustrating an example process flow through which guidance and feedback may be dynamically generated and provided to a user using an application. For example, flow may begin with a user accessing an application interface at step 1. During the use of the application, a dynamic feedback and guidance generation system (e.g., system 110 of FIGS. 1A and 1B) may monitor for application use and user interaction. For example, the system may perform screen captures of the application interface as well as event captures as it is being used by the user. Event captures may include movement of the screen (e.g., scrolling, navigating to another interface), user interactions, user input, and the like and/or combinations thereof. Step 1 may further include analyzing a variety of progress and transaction information in order to determine a context of intent so that the system is able to propose possible next actions or provide guidance for next actions based on that context. For example, the system may determine a current progress through the application or interface process based on an estimated amount of time that each portion of the interface or interface process should take a user to complete. Progress may also be determined based on dividing each portion of the interface or application process as equal steps in the overall process. The system may also evaluate whether there are hidden system errors (e.g., in the configuration of the application or the back-end system) that may affect whether a user is able to complete a particular process or step in the process. Further, the system may evaluate upcoming workflows to determine whether guidance is necessary in anticipation of upcoming requirements.

In step 2, the system may further extract text and objects from the user interface being presented to the user. Objects may include images, video, metadata and the like. In some arrangements, the text may include user input through a conversational prompt (e.g., a help chat or the like). This extracted information may then be combined with historical information to populate a reference resolution language model. For example, the historical guidance information may include prior user inquiries or on-screen information and associated context as well as corresponding resolutions provided in those situations. Those resolutions (e.g., feedback and guidance that helped a user progress through the same or a similar process or interface) may be mapped to extracted interface and user interaction information to further build the existing reference resolution language model. In some arrangements, the collected objects may also be clustered based on similarity to further tune the mappings and associations between resolutions and various interface characteristics and attributes.

In step 3, user input captured from the prior steps and/or user input captured from a current on-screen conversation prompt may be used to generate various guidance and feedback for the user of the application. Similarly, on-screen objects and other non-user-input may be captured (e.g., from prior steps or processes and/or from a current displayed interface) and also used for generating guidance feedback. In one example, as shown in step 3, both types of information—user input and non-user-input—may be fed into a dual reference resolution engine. The dual reference resolution engine may process both types of data and information to resolve the type of guidance that is desired or that would be helpful for that user. For example, the dual reference resolution engine may extract further context from on-screen objects (e.g., non-user-inputted information from an interface) to better understand user input, such as queries, entered through a chat or conversation interface element of the application. Similarly, the existence, type, and/or substance of user input (e.g., a question or request for help) may be used to determine that proactive on-screen guidance for current or upcoming portions of the interface would be helpful. The dual reference resolution engine, in one example, may output a query or other prompt that is used to generate guidance information. The query or prompt may be a natural language prompt in some arrangements.

By using a dual reference engine, intelligent real-time responses to user inquiries or other interaction may be more precise, relevant and helpful. In some examples, the dual reference engine may be used to determine whether a proactive conversation prompt (e.g., a live chat message) should be generated and provided to the user. Similarly, user input may be helpful in determining whether to provide on-screen guidance as well as an amount and substance of that guidance. In some cases, an application may be configured to provide on-screen guidance at every user input field as a default. Using a dual reference engine, a system may instead intelligently and dynamically generate on-screen guidance only in situations where user input (e.g., queries, requests for help) may indicate a need for guidance. For example, if a user has questions about the differences between types of loans, the system may use this information, in addition to context gleaned from non-user-input on-screen objects to determine that proactive guidance should be provided when the user navigates to input fields for a user to enter a desired loan interest rate or other payment terms. In contrast, if the user does not have questions about the differences between loan types, the system might not needlessly generate and display the on-screen guidance for those input fields. In some cases, presenting on-screen guidance when it is not needed or desired may clutter the display and may slow down user progress in completing a process or otherwise using the application.

In step 4, using the results of the dual reference resolution engine, the system may build proactive and/or responsive conversation prompts as well as on-screen guidance. For example, the system may use the analysis performed in step 3 to determine whether feedback and guidance is necessary. The system may then generate guidance and feedback based on the analysis performed in step 3 using the large reference resolution language model mentioned with respect to step 1. The large reference resolution language model may include information about past resolutions as well as corresponding context, application characteristics, user characteristics, user queries, interaction characteristics (e.g., amount of time spent on an interface or portions of the interface, frequency with which a user asks for help), and the like and/or combinations thereof. The information collected in step 3 may be used as input into the language model to determine one or more resolutions for the guidance that is deemed necessary or advisable. Resolutions may include computer-generated responses or guidance information. These responses and information may include text, audio, video, haptic feedback and/or combinations thereof.

In step 5, the system may determine a placement of each guidance interface element that is to be provided to the user. The placement may be determined based on a priority of the guidance. Priority may be determined in a variety of manners, including based on a sequence in which a process is to be completed, a display order of input fields in the interface, whether the information is responsive to a user inputted query, and the like and/or combinations thereof. In some examples, higher priority guidance may be placed above or in front of lower priority guidance or information. In other cases, placement may include font color, background shadows (e.g., for a guidance window), font size, font style (bold, italic, underline, etc.), window size, window outline color, and the like and/or combinations thereof.

In step 6, the system may further generate summaries and records of the guidance provided and resulting user actions. Additionally, the system may use this information to provide follow-up if certain issues with the process require additional resolution.

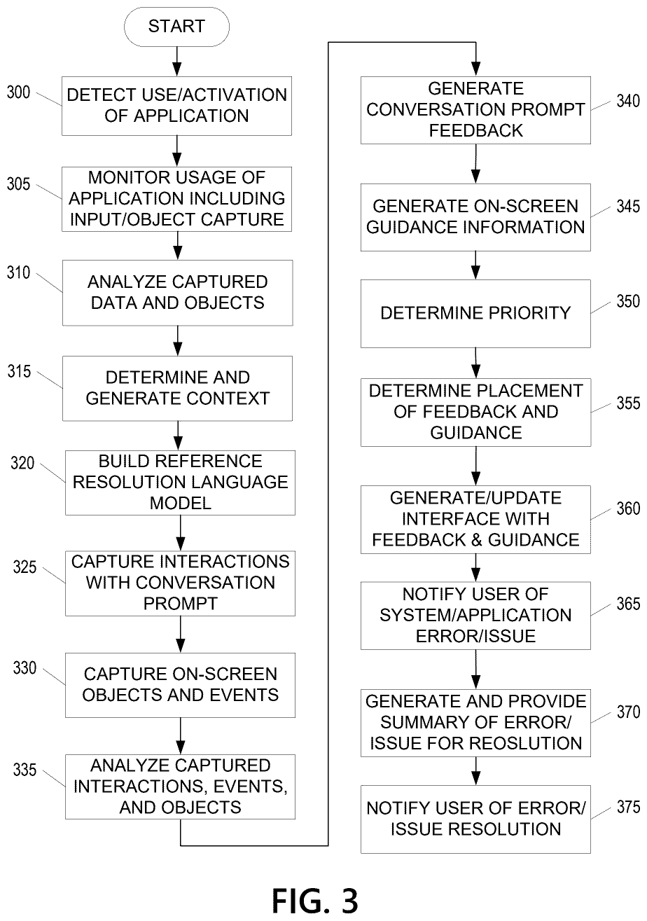

FIG. 3 is a flowchart illustrating a process for monitoring user interactions with an application and dynamically generating intelligent feedback and guidance. For example, in step 300, a dynamic feedback and guidance generation system may detect the use of an application by a user. Detection may be based on or triggered by a user accessing an on-line application (e.g., logging in, initiating execution of the application) or a notification sent from a locally executed application to an application server upon the user activating the application. Upon detecting the execution or use of the application by a user, the system may begin monitoring usage of the application in step 305. Monitoring usage of the application may include obtaining screen captures of the application interface as it is being used, obtaining the user input entered by the user, recording events such as navigation within an interface or between multiple interfaces of the same application, recording an amount of time spent on one or more portions of the application or interface, obtaining or retrieving on-screen elements such as images, text, audio, and the like and/or combinations thereof. This monitoring may be performed continuously, on a periodic basis, an aperiodic basis, and/or based on triggering events or conditions.

In step 310, the system may analyze the captured data and objects. This analysis may be used to determine a current user progress through an application process, identify one or more upcoming process flows, and identify possible application or system errors that may hinder user progress. For example, the system may capture a progress indicator displayed in the user interface to determine a current percentage progress through an application process. In another example, the system may capture error codes or prompts displayed on the screen (e.g., responsive to user input) and analyze those errors to determine whether the application includes an error that is not caused by the user's input or correctable by the user. In yet another example, the system may obtain a screen capture and extract text and images therefrom to identify input fields, processes, or other information that may be upcoming in the application's overall process flow. For example, the system may have a database that stores process flows for each application. The system may use this database of information to determine upcoming portions of the process flow for a particular application based on the captured text, images, and other objects of a current interface or portion of an interface being viewed by a user.

In step 315, the system may determine and generate a context for the user's actions and events in the application based on the captured data and objects. Context may refer to information describing a circumstance or setting of an event or action. Context may include information that further describes or clarifies a user's inquiry or that provides information to clarify elements currently displayed as part of a user interface. For example, an input prompt on an interface may ask for an identification number. The system may generate context surrounding this prompt by identifying and analyzing elements within a current interface or portions of the interface which indicates that that portion of the interface relates to driver registration or an automobile insurance application.

In step 320, the system may build a reference resolution language model based on the captured data, the generated context information, and historical resolution information. In one example, a reference resolution language model may be used to process natural language user inquiries or information displayed on an interface to identify possible resolutions (e.g., guidance or feedback) to assist a user's progress through an application process. Historical resolution information may include previous conversations and interactions with the same user and/or with other users. In some examples, only historical resolution information for the same user and the same application may be used. In other examples, only historical resolution information for the same user and the same or similar applications may be retrieved and used. In still other examples, historical resolution information for the same or similar applications may be retrieved and used (e.g., irrespective of user). In building the reference resolution language model, similarities may be identified between the existing application session and historical resolution information. Similar information such as text, images, input fields or other interactive elements, audio, video, and other objects may be clustered or grouped together and associated with a particular resolution or set of resolutions. Building the reference resolution language model may include generating one or more nodes and/or connections within an existing language model based on new contexts, new data (e.g., text, input fields, images) and/or new associations.

In step 325, the system may capture interactions and other information associated with a conversation prompt in the user interface. A conversation prompt may include an interface element such as a window that allows a user to provide natural language input. For example, the application interface may include a chat functionality through which a user may input natural language comments or inquiries to obtain help or guidance. Additionally, in step 330, the system may capture further on-screen events and objects. These events and objects may refer to objects that are not user entered. For example, the events and objects may include current text, images, metadata, audio, and/or video currently being presented on the interface being viewed by the user. Additionally or alternatively, the events and objects may include navigation of the interface and/or automated changes to the interface (e.g., resulting from execution of application code).

In step 335, the system may analyze the further captured user input (e.g., interactions with the conversation prompt in the user interface) and on-screen events and objects through a dual reference resolution engine. As discussed, a dual reference resolution engine may use each type of input (captured user input and on-screen events and objects) to determine the type and substance of guidance or feedback needed. In one example, the dual reference resolution engine may be configured to generate a natural language prompt to be fed into a language model from which a response to the prompt may be generated. The natural language prompt may be generated based on both the user input as well as the on-screen events and objects to provide more accurate context and resulting query or prompt. In one example, the system may generate the natural language prompt by combining portions of the user input with one or more key words extracted from the on-screen events and objects. If a user's input is “Where can I find the serial number?” and the system extracts content from the displayed interface that includes the words “Register your computer,” the system may use the word “computer” from the on-screen content to provide more context to the query. The dual reference resolution engine may thus produce a natural language query of “Where can I find the serial number for this computer?” In another example, metadata, such as an image description tag in a webpage, may be used to determine context. In some examples, the system may perform key word extraction from either the user input or the non-user-input interface content based on a database of known key words or relevant words or phrases.

In step 340, the system may generate conversation prompt feedback. In some cases, the conversation prompt feedback may be proactive. That is, the conversation prompt feedback might not be responsive to a user query or request for assistance. Instead, the conversation prompt feedback may be triggered by user input in the application interface (e.g., a user incorrect inputs address information). In other examples, conversation prompt feedback may be both proactive and responsive.

In step 345, the system may further generate on-screen guidance separate and distinct from the conversation prompt feedback. In some cases, the on-screen guidance may be guidance and information that is not triggered by user input, while conversation prompt feedback may be triggered and responsive to user input. For example, on-screen guidance may be related or triggered by where a user is currently within an application process and/or what is currently displayed as part of the interface currently viewed by the user.

The conversation prompt feedback and the on-screen guidance may be generated using the reference resolution language model described with respect to step 320. For example, the system may pass the output from the dual reference resolution to the reference resolution language model to identify one or more resolutions that may be used to advance the user's progress through the application process. Resolutions may include prior feedback or guidance provided to users to resolve similar issues or inquiries or to address similar interfaces or aspects of the interface. In some examples, resolutions may include a feedback template that may be populated with application and/or user specific information. For example, a template may be defined for guiding a user through entering travel information when booking a flight. This same template may be used for multiple different flight applications by inserting or populating the template with flight-specific or airline-specific information including airline name, flight number, images (e.g., livery or logos), seat arrangements, and the like and/or combinations thereof. The guidance information, however, may be predefined in the template and be generally the same for each iteration of the populated template. Templates may be associated with different resolutions and retrieved if a particular resolution is identified as being relevant to a current application session.

In step 350, once the conversation prompt feedback and on-screen guidance have been determined and generated, the system may further determine a priority of the guidance and feedback information. Once a priority has been determined, in step 355, the system may determine a placement of the prompt feedback and the on-screen guidance based on the determined priority.

In step 360, the system may subsequently generate or update the application interface currently being viewed by the user with the generated conversation prompt feedback and the generated on-screen guidance. In one example, an existing conversation window may be populated with the generated conversation prompt feedback. In some cases, depending on the determined priority, the existing conversation window may also be moved. Similar processes may be performed with respect to an example on-screen guidance window or display.

If the system determines that a system-or application-level error or other issue prevents user from completing the process, in step 365, the system may notify the user of issue and record a summary of the captured information for further resolution. The identification of such errors or issues may be based on analysis of at least a portion of the captured information (e.g., from steps 310-315 and 330-335). Such notification may improve the user experience by informing the user that their difficulty progressing through the application process may be the result of an underlying system or application issue, and not due to their interactions.

In step 370, the system may further provide the summary of the error for resolution. In step 375, the system may then notify user when issue has been resolved. By notifying the user, the user may know when to return to the application to complete the application process.

According to one or more arrangements, feedback and guidance may further include modification to a layout or presentation of the interface. For example, various fields or objects within the interface may be re-ordered in order to assist a user through the application process. Such re-ordering or modification of the interface may include modifying the underlying code to change the sequence in which interface elements are displayed. In another example, certain words, images, and other objects may be modified in appearance to emphasize or de-emphasize the user's attention. Such changes may also be implemented by modifying the underlying interface code (e.g., modifying web page HTML code) and reloading the interface.

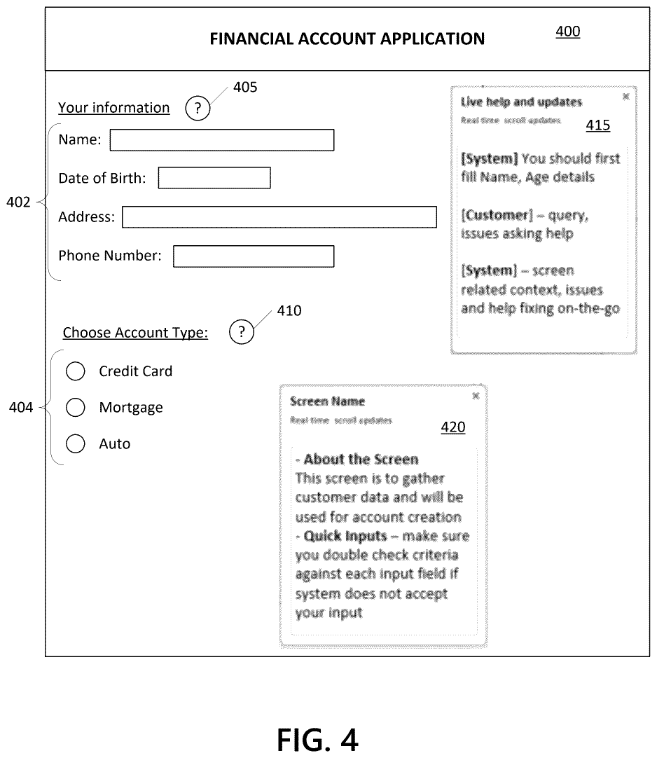

FIG. 4 illustrates an example user interface providing feedback and guidance information according to one or more aspects described herein. In this example, interface 400 may be configured for a financial account application or registration. The interface 400 may include various input fields 402, 404, interactive assistance elements 405, 410, and guidance information displays or windows 415, 420. Input fields 402 and 404 may be configured to solicit and obtain information from a user seeking to obtain or register a financial account. These fields 402, 404 may include prompts for user information as well as a prompt for selecting a type of account the user is seeking to register or obtain. Fields 402 are illustrated as character input fields, but may also include other types of fields such as drop down input elements, check boxes, radio buttons and the like and/or combinations thereof. Fields 404 include radio buttons for selecting an account type but may also include other types of input fields such as character input fields, drop down menus, check boxes, and the like and/or combinations thereof. Assistance elements 405 and 410 may be selectable interface elements that cause information to be displayed or otherwise provided upon selection. For example, upon a user clicking on element 405, a window may be displayed providing additional explanation for a corresponding portion of the interface.

Interface 400 further includes guidance elements, including a conversation or chat window 415. Chat window 415 allows the system to provide information to the user, and the for user to respond with further inquiries or comments. In window 415, the guidance system has provided an instructional message to fill in name and age details first. This message may be sent proactively (i.e., not in response to a user message in the chat window 415) or responsive to user input. In some cases, the message may be sent upon determining that the user has been idle or focused on the fields 402 for a certain amount of time. In response to this guidance, the user may then enter queries or follow-up comments requesting further assistance that may be related to unrelated to the system's first message. For example, the user query may be “What format should I enter my birthdate in?” The system, upon receiving this inquiry, may respond with further guidance based on screen related context, thereby addressing issues dynamically and in real-time. Feedback and guidance provided through chat window 415 may be updated responsive to the user input and/or may be updated to include proactive information based on the user's progress through the application.

On-screen guidance window 420 may also provide assistance, feedback, and information to guide a user through the application interface 400. In some examples, the screen guidance information in window 420 might be provided based on non-user input on-screen information such as the fields that are currently displayed. For example, the screen guidance information may be proactive guidance based on knowledge of the current displayed interface content, upcoming interface elements and process flows, and knowledge about the user. Guidance window 420 may continuously update based on a current disposition of the interface and application process flow. For example, as a user continues to scroll through a current interface or to navigate to a subsequent interface of the application, the guidance window 420 may update and provide further guidance and information.

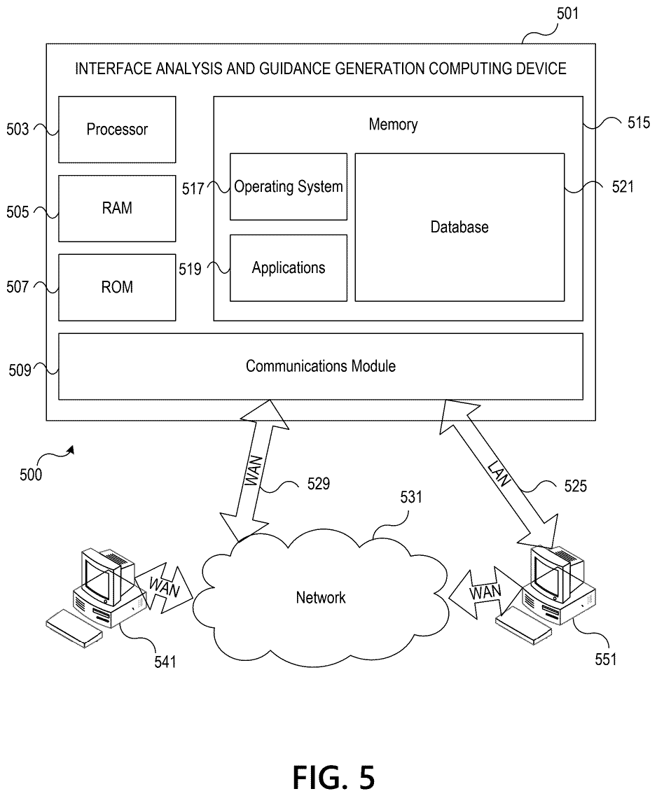

FIG. 5 depicts an illustrative operating environment in which various aspects of the present disclosure may be implemented in accordance with one or more example embodiments. Referring to FIG. 5, computing system environment 500 may be used according to one or more illustrative embodiments. Computing system environment 500 is only one example of a suitable computing environment and is not intended to suggest any limitation as to the scope of use or functionality contained in the disclosure. Computing system environment 500 should not be interpreted as having any dependency or requirement relating to any one or combination of components shown in illustrative computing system environment 500.

Computing system environment 500 may include interface analysis and guidance generation computing device 501 having processor 503 for controlling overall operation of interface analysis and guidance generation computing device 501 and its associated components, including Random Access Memory (RAM) 505, Read-Only Memory (ROM) 507, communications module 509, and memory 515. Interface analysis and guidance generation computing device 501 may include a variety of computer readable media. Computer readable media may be any available media that may be accessed by interface analysis and guidance generation computing device 501, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by interface analysis and guidance generation computing device 501.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on interface analysis and guidance generation computing device 501. Such a processor may execute computer-executable instructions stored on a computer-readable medium.

Software may be stored within memory 515 and/or storage to provide instructions to processor 503 for enabling interface analysis and guidance generation computing device 501 to perform various functions as discussed herein. For example, memory 515 may store software used by interface analysis and guidance generation computing device 501, such as operating system 517, application programs 519, and associated database 521. Also, some or all of the computer executable instructions for application modification and customization computing device 501 may be embodied in hardware or firmware. Although not shown, RAM 505 may include one or more applications representing the application data stored in RAM 505 while interface analysis and guidance generation computing device 501 is on and corresponding software applications (e.g., software tasks) are running on interface analysis and guidance generation computing device 501.

Communications module 509 may include a microphone, keypad, touch screen, and/or stylus through which a user of interface analysis and guidance generation computing device 501 may provide input, and may also include one or more of a speaker for providing audio output and a video display device for providing textual, audiovisual and/or graphical output. Computing system environment 500 may also include optical scanners (not shown).

Interface analysis and guidance generation computing device 501 may operate in a networked environment supporting connections to one or more other computing devices, such as computing device 541 and 551. Computing devices 541 and 551 may be personal computing devices or servers that include any or all of the elements described above relative to interface analysis and guidance generation computing device 501.

The network connections depicted in FIG. 5 may include Local Area Network (LAN) 525 and Wide Area Network (WAN) 529, as well as other networks. When used in a LAN networking environment, interface analysis and guidance generation computing device 501 may be connected to LAN 525 through a network interface or adapter in communications module 509. When used in a WAN networking environment, interface analysis and guidance generation computing device 501 may include a modem in communications module 509 or other means for establishing communications over WAN 529, such as network 531 (e.g., public network, private network, Internet, intranet, and the like). The network connections shown are illustrative and other means of establishing a communications link between the computing devices may be used. Various well-known protocols such as Transmission Control Protocol / Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A method comprising:
detecting, by an application server comprising at least one processor, a user device activating an electronic application, wherein the application server is configured to provide one or more applications to a plurality of user devices;
upon detecting activation of the electronic application by the user device, initiate monitoring, by the application server, of one or more characteristics of a use of the electronic application by a user of the user device, wherein the one or more characteristics includes an amount of time spent on one or more interfaces of the electronic application;
capturing, by the application server, one or more interface portions of the one or more interfaces of the electronic application;
extracting, by the application server, objects from the captured one or more interface portions, the objects including text displayed in the captured one or more interface portions and user input entered into at least one of the one or more interface portions;
determining, by the application server, a context associated with the user input and the one or more interface portions;
building, by the application server, a reference language model based on the determined context, the user input, and the extracted objections;
generating, by the application server, a natural language prompt for obtaining guidance assisting the user in completing the one or more interface portions, wherein generating the prompt includes inputting the user input and the extracted objects into a dual reference resolution engine, the dual reference resolution engine;
generating, by the application server, guidance information by inputting the natural language prompt into a resolution language model, wherein the guidance information includes conversation guidance information and on-screen guidance information, wherein the conversation guidance information is configured for display in a first interface element including a chat functionality of the application and wherein the on-screen guidance information is configured for display in a second interface element separate from the chat functionality; and
electronically modifying, by the application server, the one or more interfaces of the electronic application, in real-time, to include the guidance information.

2. The method of claim 1, wherein electronically modifying the one or more interfaces of the electronic application, in real-time, to include the guidance information includes:
adding the conversation guidance information into a chat window corresponding to the chat functionality of the application; and
adding the on-screen guidance information into a guide prompt window separate from the chat window.

3. The method of claim 2, wherein the conversation guidance information is generated responsive to the user input.

4. The method of claim 2, wherein the one or more interface portions correspond to a first process of the application, and
wherein the on-screen guidance information is generated by determining that a second process follows the first process of the application, wherein the on-screen guidance information provides user instructions for completing the second process.

5. The method of claim 1, further comprising:
determining a first priority of the conversation guidance information and a second priority of the on-screen guidance information; and
determining a placement of the conversation guidance information and the on-screen guidance information based on the determined first and second priorities.

6. The method of claim 1, wherein electronically modifying the one or more interfaces of the electronic application further includes moving a location of at least one element of the one or more user interface portions from a first location to a second location.

7. The method of claim 1, wherein the monitoring of one or more characteristics of the use of the electronic application by the user of the user device includes capturing the one or more characteristic at a specified frequency.

8. An apparatus comprising:
a processor; and
memory storing computer-readable instructions that, when execute, cause the apparatus to:
detect a user device activating an electronic application;
upon detecting activation of the electronic application by the user device, initiate monitoring of one or more characteristics of a use of the electronic application by a user of the user device, wherein the one or more characteristics includes an amount of time spent on one or more interfaces of the electronic application;
capture one or more interface portions of the one or more interfaces of the electronic application;
extract objects from the captured one or more interface portions, the objects including text displayed in the captured one or more interface portions and user input entered into at least one of the one or more interface portions;
determine a context associated with the user input and the one or more interface portions;
build a reference language model based on the determined context, the user input, and the extracted objections;
generate a natural language prompt for obtaining guidance assisting the user in completing the one or more interface portions, wherein generating the prompt includes inputting the user input and the extracted objects into a dual reference resolution engine, the dual reference resolution engine;
generate guidance information by inputting the natural language prompt into a resolution language model, wherein the guidance information includes conversation guidance information and on-screen guidance information, wherein the conversation guidance information is configured for display in a first interface element including a chat functionality of the application and wherein the on-screen guidance information is configured for display in a second interface element separate from the chat functionality; and
electronically modify the one or more interfaces of the electronic application, in real-time, to include the guidance information.

9. The apparatus of claim 8, wherein electronically modifying the one or more interfaces of the electronic application, in real-time, to include the guidance information includes:
adding the conversation guidance information into a chat window corresponding to the chat functionality of the application; and
adding the on-screen guidance information into a guide prompt window separate from the chat window.

10. The apparatus of claim 9, wherein the conversation guidance information is generated responsive to the user input.

11. The apparatus of claim 8, wherein the one or more interface portions correspond to a first process of the application, and
wherein the on-screen guidance information is generated by determining that a second process follows the first process of the application, wherein the on-screen guidance information provides user instructions for completing the second process.

12. The apparatus of claim 8, wherein the instructions, when executed, further cause the apparatus to:
determine a first priority of the conversation guidance information and a second priority of the on-screen guidance information; and
determine a placement of the conversation guidance information and the on-screen guidance information based on the determined first and second priorities.

13. The apparatus of claim 8, wherein electronically modifying the one or more interfaces of the electronic application further includes moving a location of at least one element of the one or more user interface portions from a first location to a second location.

14. The apparatus of claim 8, wherein the monitoring of one or more characteristics of the use of the electronic application by the user of the user device includes capturing the one or more characteristics at a specified frequency.

15. A non-transitory computer-readable medium storing computer-readable instructions that, when executed, cause an apparatus to:
detect a user device activating an electronic application;
upon detecting activation of the electronic application by the user device, initiate monitoring of one or more characteristics of a use of the electronic application by a user of the user device, wherein the one or more characteristics includes an amount of time spent on one or more interfaces of the electronic application;
capture one or more interface portions of the one or more interfaces of the electronic application;
extract objects from the captured one or more interface portions, the objects including text displayed in the captured one or more interface portions and user input entered into at least one of the one or more interface portions;
determine a context associated with the user input and the one or more interface portions;
build a reference language model based on the determined context, the user input, and the extracted objections;
generate a natural language prompt for obtaining guidance assisting the user in completing the one or more interface portions, wherein generating the prompt includes inputting the user input and the extracted objects into a dual reference resolution engine, the dual reference resolution engine;
generate guidance information by inputting the natural language prompt into a resolution language model, wherein the guidance information includes conversation guidance information and on-screen guidance information, wherein the conversation guidance information is configured for display in a first interface element including a chat functionality of the application and wherein the on-screen guidance information is configured for display in a second interface element separate from the chat functionality; and
electronically modify the one or more interfaces of the electronic application, in real-time, to include the guidance information.

16. The non-transitory computer-readable medium of claim 15, wherein electronically modifying the one or more interfaces of the electronic application, in real-time, to include the guidance information includes:
adding the conversation guidance information into a chat window corresponding to the chat functionality of the application; and
adding the on-screen guidance information into a guide prompt window separate from the chat window.

17. The non-transitory computer-readable medium of claim 16, wherein the conversation guidance information is generated responsive to the user input.

18. The non-transitory computer-readable medium of claim 15, wherein the one or more interface portions correspond to a first process of the application, and
wherein the on-screen guidance information is generated by determining that a second process follows the first process of the application, wherein the on-screen guidance information provides user instructions for completing the second process.

19. The non-transitory computer-readable medium of claim 15, wherein the instructions, when executed, further cause the apparatus to:
determine a first priority of the conversation guidance information and a second priority of the on-screen guidance information; and
determine a placement of the conversation guidance information and the on-screen guidance information based on the determined first and second priorities.

20. The non-transitory computer-readable medium of claim 15, wherein electronically modifying the one or more interfaces of the electronic application further includes moving a location of at least one element of the one or more user interface portions from a first location to a second location.
